(19) United States
(12) Patent Application Publication
(10) Pub. No.: US 2026/0126654 A1
(43) Pub. Date: May 7, 2026

(54) LARGE FIELD OF VIEW CURVED LIGHTGUIDE WITH COMPACT INCOUPLER

(71) Applicant: GOOGLE LLC, Mountain View, CA (US)

(72) Inventor: Ozan Cakmakci, San Bruno, CA (US)

(21) Appl. No.: 19/375,522

(22) Filed: Oct. 31, 2025

Related U.S. Application Data
(60) Provisional application No. 63/715,265, filed on Nov. 1, 2024.

(51) Int. Cl. G02B 27/01; G02B 5/18; G06T 19/00

(52) U.S. Cl. CPC G02B 27/0172; G02B 5/189; G06T 19/006; G02B 2027/0116; G02B 2027/0178

(57) ABSTRACT

An eyewear display device implements a curved lightguide to form an intermediate image between an incoupler and an outcoupler. The curved lightguide produces an approximately 20-degree diagonal field of view (FOV) full-color display having approximately 10% red, blue, green efficiency with uniform color and luminance for a micro-display at a temple of an eyewear display device. The curved lightguide incorporates freeform mirror incouplers and/or outcouplers and color-corrected relay optics. Using an intermediate image stage in the optical pathway allows for use of a compact incoupler that does not exceed a thickness of the curved lightguide.

### BACKGROUND

In eyewear display devices, light from an image source is coupled into a lightguide substrate, generally referred to as a waveguide or lightguide, by an optical input coupling element, such as an in-coupling grating (i.e., an “input coupler” or “incoupler”), which can be formed on a surface, or multiple surfaces, of the substrate or disposed within the substrate. Once the light beams have been coupled into the lightguide, the light beams are “guided” through the substrate, typically by multiple instances of total internal reflection (TIR) or by a coated surface(s). The guided light beams are then directed out of the lightguide by an output optical coupling (i.e., an “output coupler” or “outcoupler”), which can also take the form of an optical grating (e.g., a diffractive, reflective, or refractive grating and/or one or more mirrors). The outcoupler directs the light at an eye relief distance from the lightguide, forming an exit pupil within which a virtual image generated by the image source can be viewed by a user (i.e., a wearer) of the display device. In many instances, an exit pupil expander, which can also take the form of an optical grating, is arranged in an intermediate stage between the incoupler and outcoupler to receive light that is coupled into the lightguide by the incoupler, expand the light, and redirect the light towards the outcoupler.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 illustrates an eyewear display device incorporating a curved lightguide configured to form an intermediate image in accordance with some embodiments.

FIG. 2 illustrates an example of a curved lightguide having a compact incoupler and color-corrected relay optics in accordance with some embodiments.

FIG. 3 illustrates another example of a curved lightguide having a compact incoupler and color-corrected relay optics in an etendue-conserving configuration in accordance with some embodiments.

FIG. 4 illustrates a perspective view of a five-element relay optics assembly usable with the curved lightguide of FIG. 2 in accordance with some embodiments.

FIG. 5 illustrates a method of operation of a lightguide in accordance with some embodiments.

### DETAILED DESCRIPTION

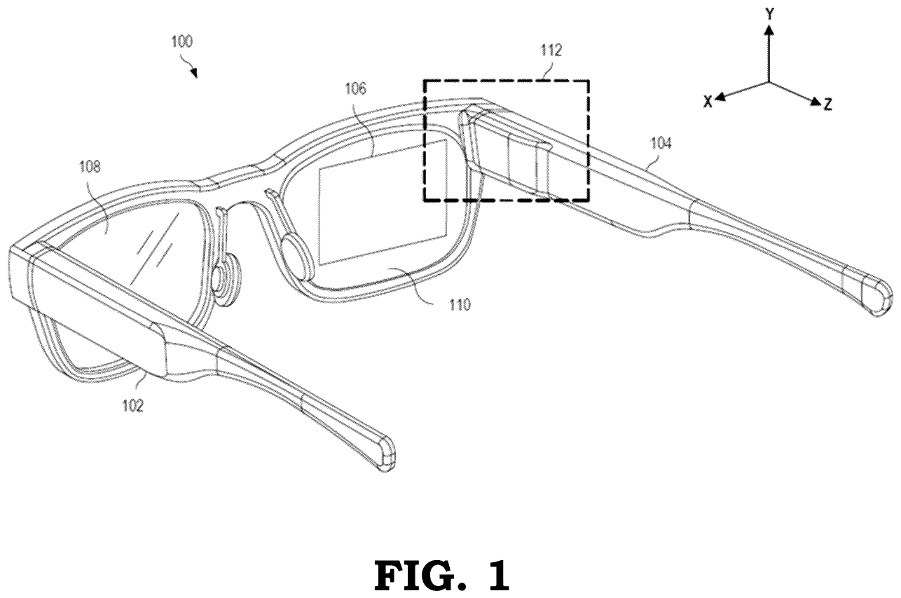

FIGS. 1-3 illustrate various techniques for implementing a curved lightguide to form an intermediate image between an incoupler and an outcoupler. In some embodiments, the curved lightguide is a thin polymer lightguide that produces an approximately 20-degree diagonal field of view (FOV) for a micro-display at a temple of an eyewear display device. In some embodiments, the curved lightguide provides a full-color display having approximately 10% red, blue, green efficiency (e.g., nits to nits efficiency) with uniform color and luminance. Aspects of the present disclosure incorporate freeform mirror incouplers and/or outcouplers to improve manufacturability (e.g., injection molding). Using an intermediate image stage in the optical pathway allows for use of a compact incoupler that does not exceed a thickness of the curved lightguide, while color-corrected relay optics are incorporated to meet optical performance requirements.

FIG. 1 illustrates an example display system 100 incorporating a thin 20-degree fOV full-color efficient curved polymer lightguide in accordance with some embodiments. It should be understood that the lightguide configurations of one or more embodiments are not limited to display system 100 of FIG. 1 and apply to other display systems. In at least some embodiments, the display system 100 comprises a support structure 102 that includes an arm 104, which houses a light engine configured to project images toward the eye of a user such that the user perceives the projected images as being displayed in a FOV area 106 of a display at one or both of lens elements 108, 110. In the depicted embodiment, the display system 100 is a near-eye display system in the form of an eyewear display device that includes the support structure 102 configured to be worn on the head of a user and has a general shape and appearance of an eyeglasses frame. The support structure 102 includes various components to facilitate the projection of such images toward the eye of the user, such as light engines, optical scanners, and/or lightguides. In at least some embodiments, the support structure 102 further includes various sensors, such as one or more front-facing cameras, rear-facing cameras, other light sensors, motion sensors, accelerometers, and the like. The support structure 102 can further include one or more radio frequency (RF) interfaces or other wireless interfaces, such as a Bluetooth™ interface, a Wireless Fidelity (WiFi) interface, and the like.

Further, in at least some embodiments, the support structure 102 includes one or more batteries or other portable power sources for supplying power to the electrical components of the display system 100. In at least some embodiments, some or all of these components of the display system 100 are fully or partially contained within an inner volume of support structure 102, such as within a temple region of the arm 104 in region 112 of the support structure 102. It should be noted that while an example form factor is depicted, it will be appreciated that in other embodiments, the display system 100 may have a different shape and appearance from the eyeglasses frame depicted in FIG. 1.

In some embodiments, one or both of the lens elements 108, 110 are used by the display system 100 to provide an augmented reality (AR) or mixed reality (MR) display in which rendered graphical content is superimposed over or otherwise provided in conjunction with a real-world view as perceived by the user through the lens elements 108, 110. For example, display light used to form a perceptible image or series of images may be projected by a light engine of the display system 100 onto the eye of the user via a series of optical elements, such as a lightguide formed at least partially in the corresponding lens element, one or more scan mirrors, and/or one or more optical relays. Thus, the lens elements 108, 110 each include at least a portion of a lightguide that routes display light received by an incoupler, or multiple incouplers, of the lightguide to an outcoupler of the lightguide, which outputs the display light toward an eye of a user of the display system 100. The display light is modulated and scanned onto the eye of the user such that the user perceives the display light as an image. In addition, each of the lens elements 108, 110 is sufficiently transparent to allow a user to see through the lens elements to provide a FOV of the user's real-world environment such that the image appears superimposed over at least a portion of the real-world environment.

In at least some embodiments, the light engine is a micro-display, a matrix-based projector, a digital light processing-based projector, a scanning laser projector, or any combination of a modulative light source such as a laser or one or more light-emitting diodes (LEDs) and a dynamic reflector mechanism such as one or more dynamic scanners or digital light processors. The light engine, in at least some embodiments, includes multiple micro-LEDs. The light engine is communicatively coupled to a controller and a non-transitory processor-readable storage medium or memory storing processor-executable instructions and other data that, when executed by the controller, cause the controller to control the operation of the light engine. In at least some embodiments, the controller manages the content and illumination of a micro-display and is communicatively coupled to a processor (not shown) that generates the content to be displayed at the display system 100. The micro-display forms an image intended to cover a defined FOV area 106 (or a portion thereof) of the display system 100. The FOV area 106 corresponds to the area of the display that is illuminated and viewable by the user, determined by the image projected through the optical system. The micro-display projects image content to be displayed on one of the lens elements 108, 110 at which the FOV area 106 is visible to the user. The controller regulates the power and addressing of the individual micro-LED pixels to control the luminance, color, and content of the displayed image, effectively determining the visual properties of the FOV area 106. Generally, it is desirable for a display to have a wide FOV to accommodate the outcoupling of light across a wide range of angles. The range of different user eye positions that will be able to see the display is referred to as the eyebox of the display.

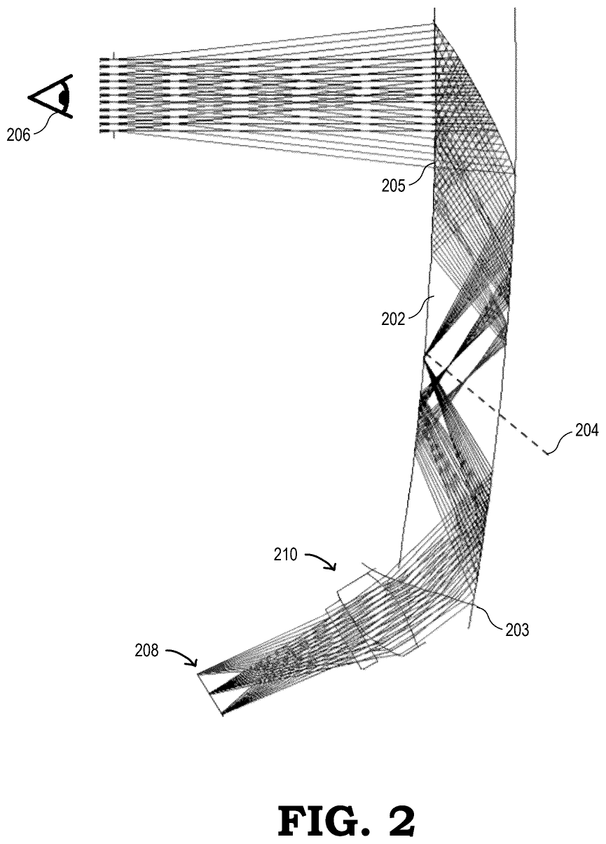

FIG. 2 depicts a portion of a lightguide 202 that is incorporated into one or both of the lens elements 108, 110 in some embodiments. In some embodiments, the lightguide 202 is curved and focuses display light to an intermediate image 204 within the lightguide 202 between the incoupler 203 and the outcoupler 205. Focusing the display light at the intermediate image 204 facilitates reduction of the footprint of the incoupler 203. For example, by focusing light in the lightguide 202 to an image plane between the incoupler 203 and the outcoupler 205, the thickness of the incoupler 203 can remain limited to the thickness of the lightguide 202. An incoupler that matches (i.e., is substantially equal to) the thickness of the lightguide 202 enhances the cosmetic appeal and facilitates industrial design of eyewear display devices incorporating such lightguides. In some embodiments, one or both of the incoupler 203 and the outcoupler 205 are freeform mirrors, which can enhance manufacturability by enabling injection molding. The term “freeform” refers to a surface that does not have symmetry around any axis.

In some embodiments, the shapes of each of the eye-side surface (see eye 206) of the curved lightguide 202, the world-side surface of the curved lightguide 202 (opposite from the eye 206), the freeform surface of the incoupler 203, and the freeform surface of the outcoupler 205 are described by a height (also referred to as a sag) z from each point (x,y) along a plane, wherein r is a base sphere term and j is an index:

$$Z = \frac{c {r}^{2}}{1 + \sqrt{1 - ( 1 + k ) {c}^{2} {r}^{2}}} + {\sum }_{j = 2}^{66} {C}_{j} {x}^{m} {y}^{n} \qquad ( 1 )$$

$$where j = \frac{{( m + n )}^{2} + m + 3 n}{2} + 1 \qquad ( 2 )$$

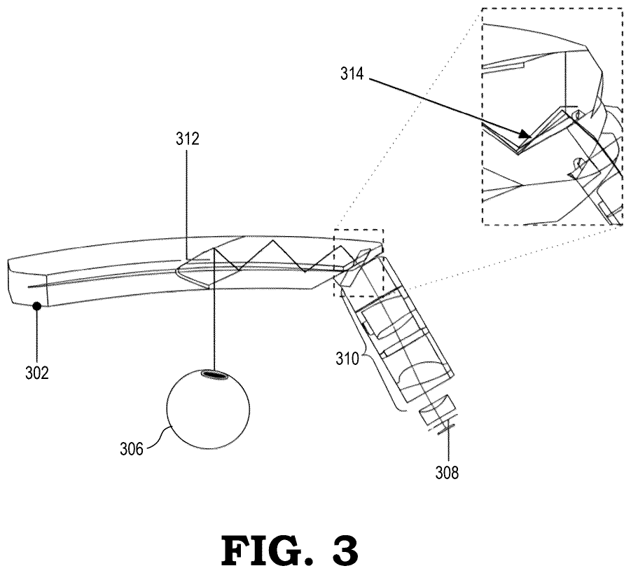

Accordingly, in some embodiments, a sag of at least one of the freeform surfaces is defined by a sum of a base sphere term and a polynomial term. As shown in FIG. 2, some embodiments receive light from a compact micro-display 208 via compact color-corrected relay optics 210. Using these techniques, a 20-degree diagonal FOV can be achieved with minimal or no artifacts and distortion for a temple-mounted micro-display using a curved lightguide in an etendue-conserving configuration, as shown in FIG. 3. Etendue is a geometric property of an optical system that quantifies its spatial extent (area) and angular spread (solid angle). Defined as the product of the light's area and its collection solid angle (the specific solid angle subtended by the aperture of a lens or optical system as viewed from the position of the light source or emitter), this quantity is conserved in an ideal optical system, setting a fundamental limit on how much light can be collected and imaged. As shown in FIG. 3, a lightguide 302 and an internal dielectric coating 312 direct light produced by a micro-display 308 and transmitted through a set of color-corrected relay optics 310 to a user's eye 306. As shown in the detail view in FIG. 3, an intermediate image is formed at an intermediate position 314 within the lightguide 302.

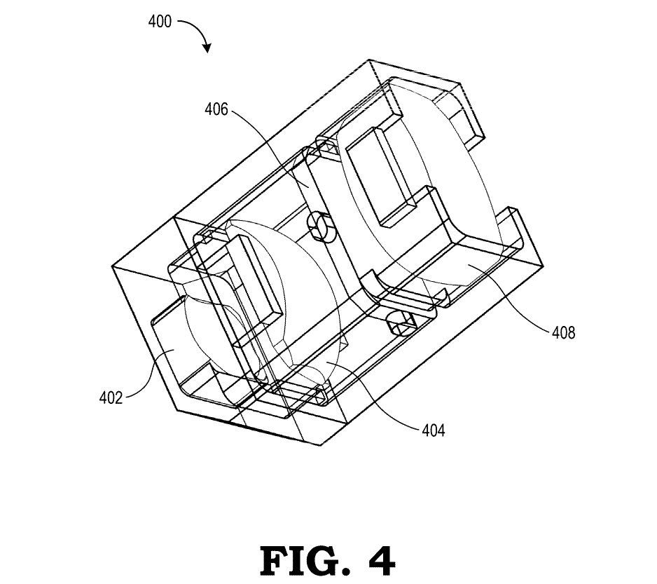

FIG. 4 illustrates a perspective view of relay optics 400 usable with the curved lightguide 202 of FIG. 2, e.g., as the relay optics 210 or as the curved lightguide 302 of FIG. 3, e.g., as the relay optics 310 in accordance with some embodiments. In some embodiments, the relay optics 400 include a first lens 402, a second lens 404, an optical kinoform 406, and a third lens 408. A kinoform is a high-efficiency diffractive optical element defined by a continuous, precisely sculpted surface relief profile, often described as a blazed or phase Fresnel lens (e.g., modulo 2π of the phase function). The structure of the kinoform 406 is typically mathematically derived to introduce a specific phase shift across the wavefront, “wrapping” the required phase change every 2π radians, which allows the kinoform 406 to focus or shape light with nearly 100% efficiency at a single design wavelength. This design makes it significantly thinner and lighter than conventional refractive lenses and particularly useful for correcting chromatic aberrations.

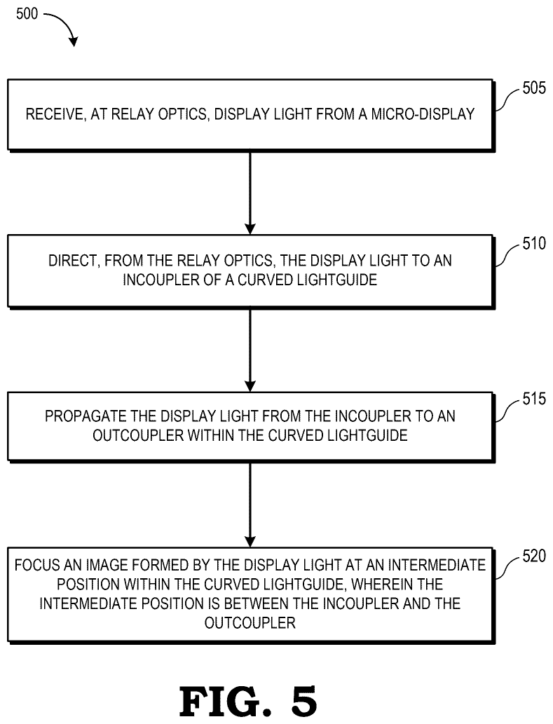

As shown in FIG. 5, a method 500 of operation of the lightguide 202 of FIG. 2 can include, at block 505, receiving, at relay optics such as the relay optics 210 of FIG. 2 or the relay optics 310 of FIG. 3, display light from a micro-display such as the micro-display 208 of FIG. 2 or the micro-display 308 of FIG. 3. In some embodiments, at block 510, the method 500 includes directing, from the relay optics, the display light to an incoupler 203 of the curved lightguide 202. In examples where the relay optics 210 are color-corrected relay optics, directing the display light can comprise passing the display light through a kinoform such as the optical kinoform 406 of FIG. 4. In some embodiments, at block 515, the method 500 further includes propagating the display light from the incoupler 203 to an outcoupler 205 within the curved lightguide 202. In some instances, propagating the display light generates a diagonal FOV of approximately 20 degrees at an eye of a user. In some embodiments, as shown at block 520 of FIG. 5, the method 500 comprises focusing an image formed by the display light at an intermediate position such as the intermediate position 204 of FIG. 2 or the intermediate position 314 of FIG. 3 within a curved lightguide such as the curved lightguide 202 of FIG. 2 or the curved lightguide 302 of FIG. 3, where the intermediate position is between an incoupler and an outcoupler such as the incoupler 203 and the outcoupler 205 of FIG. 2. The method can also include outputting, from an outcoupler such as the outcoupler 205 of FIG. 2, the display light toward an eye of a user such as the eye 206 of FIG. 2 or the eye 306 of FIG. 3. In some implementations of the method, the incoupler 203 and/or the outcoupler 205 comprise freeform surfaces.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A device, comprising:
a curved lightguide configured to propagate display light from an incoupler to an outcoupler for display at an eye of a wearer of the device,
wherein the curved lightguide is configured to focus an image formed by the display light in the curved lightguide at a position between the incoupler and the outcoupler.

2. The device of claim 1, further comprising:
a frame comprising a temple region; and
a micro-display at the temple region to emit the display light toward the incoupler, wherein the curved lightguide is configured to produce a diagonal field of view of approximately 20 degrees.

3. The device of claim 1, wherein the incoupler and the outcoupler comprise freeform surfaces.

4. The device of claim 3, wherein a sag of at least one of the freeform surfaces is defined by a sum of a base sphere term and a polynomial term.

5. The device of claim 1, further comprising:
color-corrected relay optics configured to receive the display light and direct the display light to the incoupler.

6. The device of claim 5, wherein the color-corrected relay optics comprise an optical kinoform.

7. The device of claim 5, wherein the color-corrected relay optics comprise a first lens, a second lens, an optical kinoform, and a third lens.

8. The device of claim 1, wherein the curved lightguide comprises a polymer.

9. The device of claim 1, wherein a thickness of the incoupler is substantially equal to a thickness of the curved lightguide.

10. A method, comprising:
receiving, at relay optics, display light from a micro-display;
directing, from the relay optics, the display light to an incoupler of a curved lightguide;
propagating the display light from the incoupler to an outcoupler within the curved lightguide; and
focusing an image formed by the display light at an intermediate position within the curved lightguide, wherein the intermediate position is between the incoupler and the outcoupler.

11. The method of claim 10, wherein the incoupler and the outcoupler comprise freeform surfaces.

12. The method of claim 10, wherein the relay optics are color-corrected relay optics.

13. The method of claim 12, wherein directing the display light from the color-corrected relay optics comprises passing the display light through an optical kinoform.

14. The method of claim 10, wherein propagating the display light generates a diagonal field of view of approximately 20 degrees at an eye of a user.

15. The method of claim 10, further comprising:
outputting, from the outcoupler, the display light toward an eye of a user.
